(19) United States
(12) Patent Application Publication
(10) Pub. No.: US 2026/0187516 A1
(43) Pub. Date: Jul. 2, 2026

(54) NOISE LEARNING OF MEASUREMENTS WITH KNOWN STATE INITIALIZATION

(71) Applicant: International Business Machines Corporation, Armonk, NY (US)

(72) Inventors: Daniel Josef Egger, Zurich (CH); Almudena Carrera Vazquez, Thalwil (CH); Laurin Elias Fischer, Zürich (CH); Stefan Woerner, Zürich (CH)

(21) Appl. No.: 19/007,851

(22) Filed: Jan. 2, 2025

(51) Int. Cl. G06N 10/70; G06N 10/40

(52) U.S. Cl. CPC G06N 10/70; G06N 10/40

(57) ABSTRACT

One or more systems, devices, computer program products and/or computer-implemented methods of use provided herein relate to noise learning of measurements with known state initialization. For example, a system can comprise a memory that can store computer executable components and a processor that can execute the computer executable components stored in the memory. The computer executable components can comprise: an initialization component that can initialize a qubit with a known state to obtain state preparation errors of the qubit; a measurement component that can measure properties of the known state of the qubit; and an execution component that can perform, on a quantum system, cycle benchmarking for measurements on the qubit within a quantum circuit to obtain, by using the properties of the known state, a noise model of the measurements that determines state errors of the qubit from the state preparation errors.

### BACKGROUND

The subject disclosure relates to quantum error mitigation and, more specifically, to noise learning of measurements with known state initialization.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable noise learning of measurements with known state initialization are discussed.

According to an embodiment, a system is provided. The system can comprise a memory that can store computer executable components. The system can further comprise a processor that can execute the computer executable components stored in the memory, where the computer executable components can comprise an initialization component that can initialize a qubit with a known state to obtain state preparation errors of the qubit. The computer executable components can further comprise a measurement component that can measure properties of the known state of the qubit. The computer executable components can further comprise an execution component that can perform, on a quantum system, cycle benchmarking for measurements on the qubit within a quantum circuit to obtain, by using the properties of the known state, a noise model of the measurements that determines state errors of the qubit from the state preparation errors.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate noise learning of measurements with known state initialization in accordance with one or more embodiments described herein.

FIG. 2 illustrates another block diagram of an example, non-limiting system that can facilitate noise learning of measurements with known state initialization in accordance with one or more embodiments described herein.

FIG. 3 illustrates diagrams of example, non-limiting quantum circuits associated with measurement errors in accordance with one or more embodiments described herein.

FIG. 4 illustrates a diagram of an example, non-limiting Pauli transfer matrix associated with a noise model from cycle benchmarking in accordance with one or more embodiments described herein.

FIG. 5 illustrates a diagram of an example, non-limiting quantum circuit for cycle benchmarking with an initialized known state of a qubit in accordance with one or more embodiments described herein.

FIG. 6 illustrates a diagram of an example, non-limiting Rabi experiment for measuring thermal population of a qubit in accordance with one or more embodiments described herein.

FIG. 7 illustrates diagrams of example, non-limiting graphs of experiment results of the proposed method and existing methods in accordance with one or more embodiments described herein.

FIG. 8 illustrates a diagram of an example, non-limiting quantum circuit implementation in accordance with one or more embodiments described herein.

FIG. 9 illustrates a diagram of an example, non-limiting graph of experiment results of the proposed method and existing methods in accordance with one or more embodiments described herein.

FIG. 10 illustrates a flow diagram of an example, non-limiting method that can facilitate noise learning of measurements with known state initialization in accordance with one or more embodiments described herein.

FIG. 11 illustrates a flow diagram of an example, non-limiting method that can facilitate noise learning of measurements with known state initialization in accordance with one or more embodiments described herein.

FIG. 12 illustrates a flow diagram of an example, non-limiting method that can facilitate noise learning of measurements with known state initialization in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### Definitions

Qubit: A qubit is a two level quantum system and the basic unit of quantum information.

Mid-circuit measurement: A mid-circuit measurement is a measurement of a qubit in a quantum circuit that occurs before the final measurement of said qubit.

Dynamic Circuit: A dynamic circuit is a quantum circuit with mid-circuit measurements and feed-forward controlled operations based on the outcomes of the mid-circuit measurements.

Thermal state: A thermal state is a mixed state of a qubit in which the qubit reaches a stationary state if it is left unperturbed.

Tomography-based Readout Error Correction (TREX): TREX is a standard technique to mitigate readout errors for expectation value measurements.

In quantum computing, error characterization is the process of identifying and quantifying types and magnitudes of errors and noise in quantum operations. Error characterization can provide essential insights into the sources and nature of errors in quantum systems, enabling the design of effective error correction strategies, improving the reliability and fidelity of quantum computations, and facilitating the development of more robust quantum technologies. One effective method for error characterization is cycle benchmarking, which focuses on evaluating the fidelity of quantum gates. Cycle benchmarking can involve repeatedly executing a specific quantum instruction to learn the associated noise processes in the quantum instruction. By performing the quantum instruction multiple times, the decay curves that result from the repeated execution can be fitted to a model to extract error rates for the quantum instruction. Cycle benchmarking can thus allow a detailed understanding of the errors introduced during quantum operations such as measurements, contributing to the overall improvement of quantum circuit reliability and performance.

However, the noise quantities learned in cycle benchmarking can limit the effectiveness of error characterization. More specifically, the noise quantities learned in cycle benchmarking only appear as products of error sources. That is, the errors are indistinguishable from one-another since they only appear in products of errors. For instance, when learning errors in mid-circuit measurements, the state preparation error (e.g., fₛₚ) appears in cycle benchmarking within a product with a state error (e.g., fₛ), such as the bit-flip error of a qubit, and thus only the product fₛfₛₚ can be learned. Consequently, this prevents accurate noise mitigation using the noise model learned from the cycle benchmarking, as the noise model cannot effectively isolate and address the underlying error sources, thereby reducing the efficacy of noise reduction strategies in quantum systems.

Furthermore, quantum circuits can be executed on hardware at a high rate due to the implementation of either conditional or unconditional active qubit resets. A conditional active reset allows for efficient resource management by resetting only those qubits that require it based on the outcomes of prior operations. Conversely, an unconditional active reset prepares all qubits to a standard state regardless of previous computations. Such conditional and unconditional active qubit resets can enhance the throughput of quantum circuits but also play a critical role in techniques like cycle benchmarking where rapid execution of repeated instructions is essential for accurately characterizing noise and error rates. Additionally, active qubit resets can remove thermal population, allowing for improved qubit resets by ensuring that qubits are returned to a well-defined ground state. However, such active qubit resets can introduce non-trivial errors. For instance, a conditional reset carries the complexities of dynamic circuits, and an unconditional reset can result in intricate dynamics that lead to complex state preparation errors. Therefore, these active qubit resets can complicate the determination of the initial state and hinder noise learning of mid-circuit measurements, as well as final measurements.

Thus, methods and techniques (or schemes) to perform cycle benchmarking that can distinguish individual error sources and mitigate the complexities introduced by active qubit resets are desirable.

Various embodiments of the present disclosure can be implemented to produce a solution to these problems. Embodiments described herein include systems, computer-implemented methods, and computer program products that provide an implementation of cycle benchmarking that initializes a qubit with a known state to obtain state preparation of errors of the qubits, thereby enabling determination of state errors of the qubit. The methods and techniques described herein to perform cycle benchmarking can determine state prpearation errors, which enables the determination of other measurement errors in the products of errors that result from cycle benchmarking. In other words, by learning one error in the products of errors, the methods and techniques described herein can thus distingush the other errors. As a result, this can improve the effectiveness of the noise model learned from the cycle benchmarking for error mitigation by allowing for more precise corrections tailored to specific error sources, rather than applying broad, less efficient corrections based on compounded errors. Furthermore, the embodiments described herein can provide an implementation of cycle benchmarking that can mitigate the non-trivial errors and complex dynamics that result from active qubit resets.

Although the various embodiments herein are primarily described with reference to mid-circuit measurements, it should be appreciated that in one or more embodiments, the state preparation error can also be determined with respect to final measurements.

In various embodiments, a noise learning component can comprise an initialization component, a measurement component, and an execution component. In various embodiments, the initialization component can initialize a qubit in a quantum circuit with a known state. For example, the initialization component can initialize the qubit with a thermal state. In various embodiments, the measurement component can measure properties of the known state of the qubit. For example, the measurement component can measure a thermal population of the qubit. Thereafter, in various embodiments, the execution component can perform cycle benchmarking for measurements on the qubit within the quantum circuit. By performing cycle benchmarking with the qubit initialized with the known state, the execution component can thus determine, based on the properties of the known state, state preparation errors of the qubit. For example, the execution component can determine the state preparation errors of the qubit using the thermal population of the qubit. Thus, by determining the state errors of the qubit, the execution component can determine state errors of the qubit from the product of errors obtained from the cycle benchmarking. That is, from the product of state preparation errors and state errors learned from the cycle benchmarking (e.g., fₛfₛₚ), the execution component can obtain the state errors from knowledge of the state preparation errors.

In comparison to existing methods, the embodiments described herein for learning noise of measurements via benchmarking enable determination of individual errors. That is, existing methods do not provide methods to distinguish state preparation errors from measurement errors in learned noise quantities. For example, TREX involves repeatedly measuring a set of known quantum states and comparing the expected measurement outcomes with the actual results, allowing mapping of how the noise affects the readout process to build a noise model that characterizes the errors. Existing methods such as TREX learn noise quantities as products of error sources, making it difficult to isolate individual errors for precise noise learning. Additionally, TREX relies on repeated measurements in quantum circuits, where active qubit reset mechanisms are used to ensure high-rate execution. However, both conditional and unconditional qubit resets introduce non-trivial state preparation errors, and as a result, complicate the accurate learning of mid-circuit measurements and final measurement outcomes.

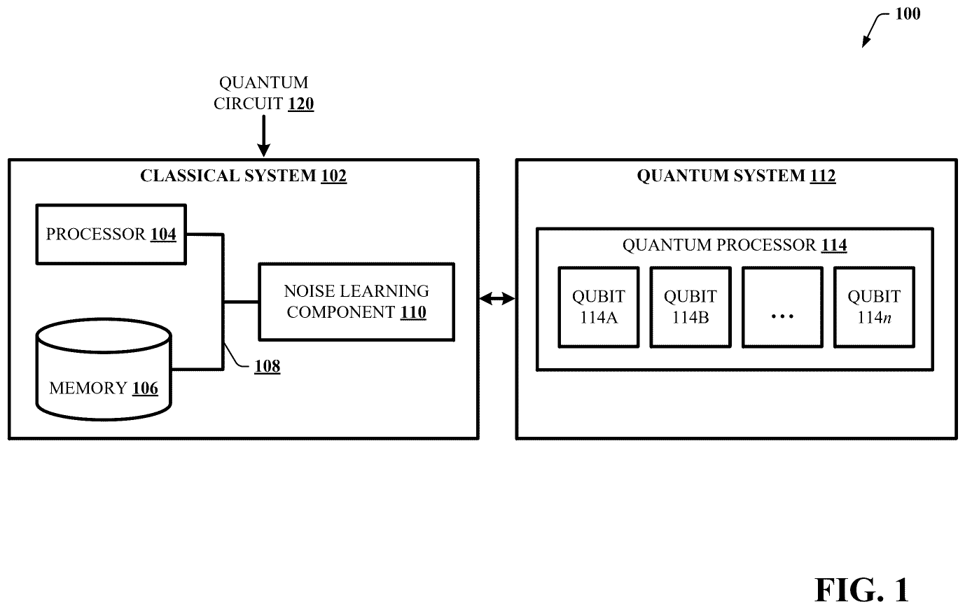

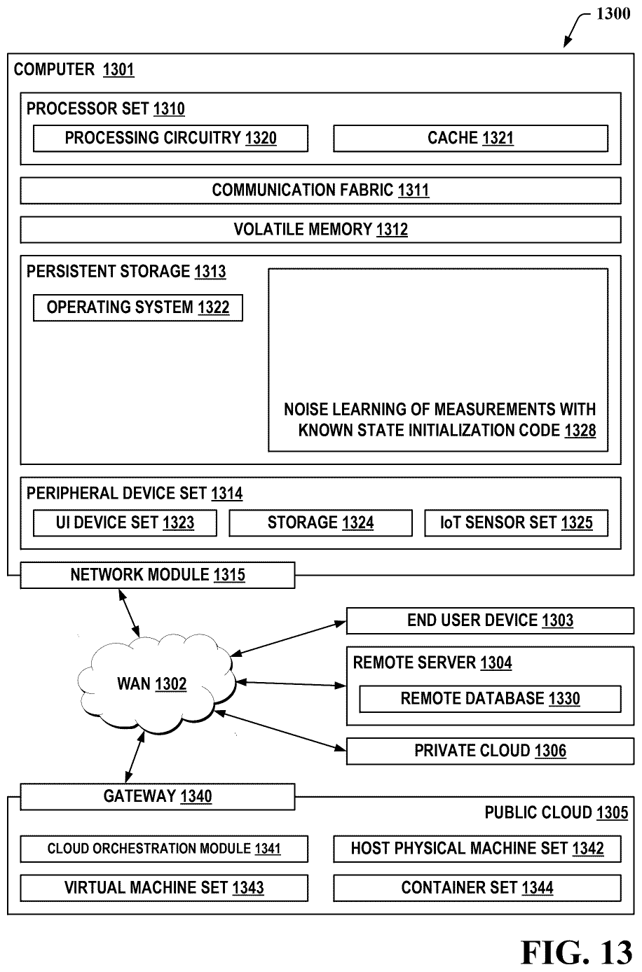

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can facilitate noise learning of measurements with known state initialization in accordance with one or more embodiments described herein.

Non-limiting system 100 and/or the components of non-limiting system 100 can be employed to use hardware and/or software to solve problems that are highly technical in nature (e.g., related to quantum error characterization, quantum error mitigation, learning of noise models, cycle benchmarking, thermal states, etc.), that are not abstract and that cannot be performed as a set of mental acts by a human. Further, some of the processes performed may be performed by specialized computers for carrying out defined tasks related to noise learning of measurements with known state initialization. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by improving the effectiveness and accuracy of noise models learned from cycle benchmarking, reduces required quantum resources for error characterization, improving error mitigation for dynamic circuits, providing a method to uncouple state preparation errors from state errors, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., noise learning component 110, initialization component 202, measurement component 204, and/or execution component 206) to perform one or more actions. In one or more embodiments, memory 106 can store computer-executable components (e.g., noise learning component 110, initialization component 202, measurement component 204, and/or execution component 206).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, and/or noise learning component 110. In an embodiment, noise learning component 110 can be comprised at least partially by quantum system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

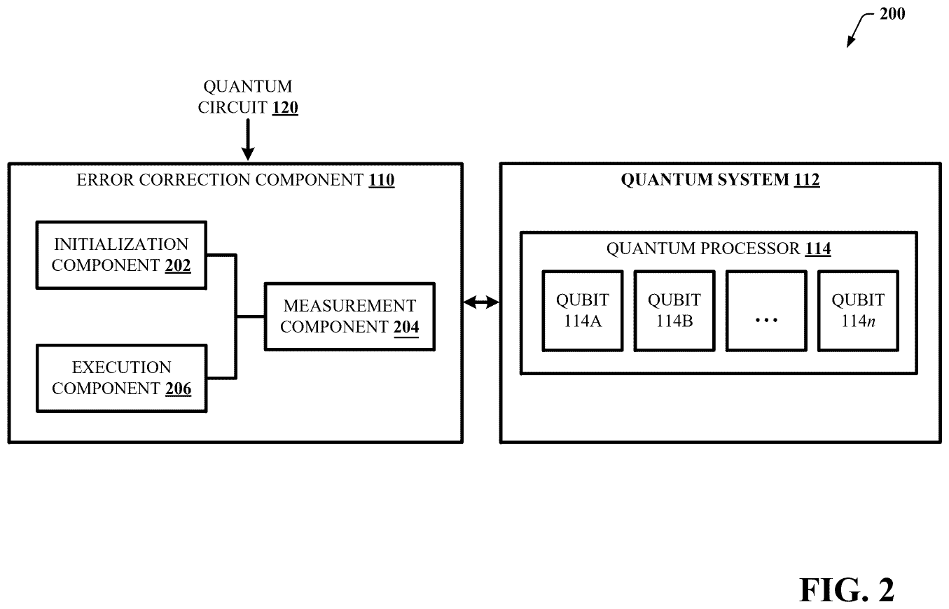

In various embodiments, noise learning component 110 can comprise initialization component 202, measurement component 204, and/or execution component 206, as illustrated in FIG. 2. In various embodiments, initialization component 202 can initialize a qubit in a quantum circuit 120 with a known state. For example, initialization component 202 can initialize the qubit in quantum circuit 120 with a thermal state. The thermal state of a qubit is a mixed state of the form ρ=e^{-H/k}^{_{B}}^{T}=(1−α)|0 [symbol] 0|+α|1 [symbol] 1|, where ρ denotes a density matrix that represents the mixed state, H denotes a Hamiltonian of the qubit, k_{B} denotes Boltzmann's constant, and T denotes a temperature of the qubit. For example, the temperature T of the qubit can typically be approximately 15 mk. In various embodiments, initialization component 202 can prepare the qubit in the known state using an unconditional qubit reset. For instance, initialization component 202 can prepare the qubit in the thermal state using an unconditional qubit reset that is governed by thermodynamics. In such case, the unconditional qubit reset can return the qubit to thermal equilibrium with its environment, where the state of the qubit is determined by the temperature and energy distribution (e.g., following a Boltzmann distribution). An unconditional qubit reset that is governed by thermodynamics, such as thermal relaxation, can be a slow process because it relies on the natural dissipation of energy from the qubit to the environment, bringing the qubit to thermal equilibrium. Accordingly, initialization component 202 can prepare, by a passive qubit reset (e.g., a qubit reset method that relies on natural processes, such as thermal relaxation, to bring the qubit to a desired state), the thermal state of the qubit by inserting a delay at the beginning of quantum circuit 120. In various embodiments, initialization component 202 can insert a delay of any suitable duration in quantum circuit 120. In various cases, initialization component 202 can insert the delay based on a defined threshold. For example, the delay can be larger than 10*T₁, where T₁ denotes the relaxation time of the qubit.

Thereafter, in various embodiments, measurement component 204 can measure properties of the known state of the qubit. For example, measurement component 204 can measure a thermal population of the qubit. The thermal population of a qubit refers to a distribution of quantum states occupied the qubit in a system at thermal equilibrium. That is, at a particular temperature T, certain energy states can be populated according to their energy levels, with lower energy states being more likely to be occupied than higher energy states. In various aspects, the thermal state, as described above, can be defined in terms of the thermal population. More specifically, the thermal state can be defined as (1−a)|0 [symbol] 0|+α|1 [symbol] 1|, where α denotes the thermal population. Thus, the qubit can be initialized in a mixed state where the thermal population represents a probability of the qubit being in the |1 [symbol] basis state, and the complement of the thermal population represents a probability of the qubit being in the |0 [symbol] basis state.

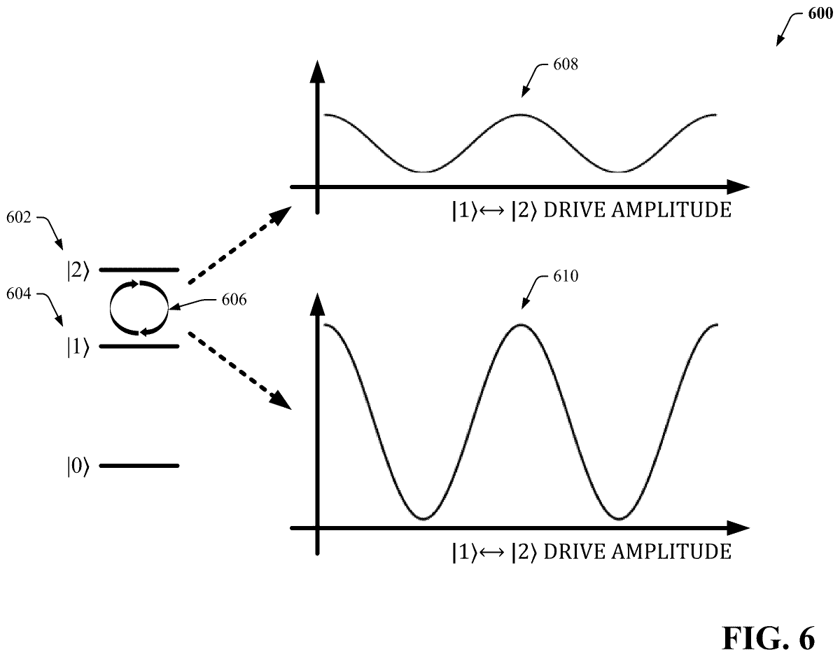

In various embodiments, measurement component 204 can measure the known state of the qubit via any suitable method or technique. For example, measurement component 204 can measure the thermal population of the qubit via Rabi experiments. In quantum computing, Rabi experiments are quantum mechanical experiments used to study the coherent oscillations of a quantum two-level system (such as a qubit) driven by an external oscillatory field. Various aspects are further described with respect to FIG. 6.

In various embodiments, following initialization of the qubit in the known state, measurement component 204 can obtain state preparation errors of the qubit based on the properties measured of the known state. For example, measurement component 204 can use the thermal population of the qubit to obtain the state preparation errors of the qubit. This can be achieved by comparing the measured thermal distribution after initialization to the expected probabilities of the known state. Any deviations from the expected known state can indicate the state preparation errors.

Thereafter, in various embodiments, execution component 206 can perform, on a quantum system (e.g., quantum system 112), cycle benchmarking for measurements on the qubit within quantum circuit 120 to learn a noise model. In various cases, such process can be applied to mid-circuit measurements or a final measurement of quantum circuit 120. In any case, as a result of the cycle benchmarking, execution component 206 can learn a noise model of the quantum instructions (e.g., measurements) repeated in the cycle benchmarking. As discussed above in the present disclosure, the errors learned in cycle benchmarking appear as products of errors, preventing determination of individual errors. For instance, the state preparation errors fₛₚ always appears in a product with the state errors of the qubit fₛ). The various embodiments herein can enable the determination of the individual errors to solve such a problem. More specifically, based on knowledge of the state preparation errors fₛₚ of the qubit, execution component 206 can thus obtain the state errors fₛ of the qubit from the product of errors fₛfₛₚ. As a result, determination of other measurement errors can be determined based on knowledge of the state preparation errors and the state errors. For example, the products of errors that result from cycle benchmarking can further include a product fₛf_{c} between the state errors fₛ and correlated errors f_{c}. Thus, based on knowledge of the state errors fₛ, execution component 206 can obtain the state errors fₛ of the qubit from the product of fₛf_{c}. Accordingly, a more effective error mitigation approach can be applied to the quantum instructions in quantum circuit 120 based on learning of the state preparation errors fₛₚ, state errors fₛ, and correlation errors f_{c} individually.

FIG. 2 illustrates a block diagram of an example, non-limiting system 200 that can facilitate noise learning of measurements with known state initialization in accordance with one or more embodiments described herein. Repetitive description of like elements and/or processes employed in respective embodiments is omitted for sake of brevity.

As described with reference to FIG. 1, noise learning component 110 can comprise initialization component 202, measurement component 204, and execution component 206. In this regard, non-limiting system 200 describes the system of noise learning component 110 and quantum system 112 that can facilitate noise learning of measurements with known state initialization.

In various aspects, noise learning component 110 can receive quantum circuit 120, where it can be desireable to learn or characterize noise of measurements in quantum circuit 120 for determining a suitable error mitigation strategy to apply. Embodiments described herein provide a method to distinguish inidividual errors learned in cycle benchmarking to enable more effective error mitigation. In various embodiments, noise learning component 110 can initialize a qubit with a known state in quantum circuit 120. For example, noise learning component 110 can initialize the qubit with a thermal state using a passive qubit reset. Further, noise learning component 110 can insert a delay into quantum circuit 120 to prepare the thermal state of the qubit. In various embodiments, noise learning component 110 can measure properties of the known state. Thus, by initializing the qubit with a known state, noise learning component 110 can determine state preparation errors of the qubit using the properties of the known state. For example, noise learning component 110 can measure a thermal population of the qubit. The thermal population can then be used to determine the state preparation errors of the qubit. Thereafter, in various embodiments, noise learning component 110 can perform cycle benchmarking to learn products of errors for the measurements. As a result, noise learning component 110 can separate the state preparation errors from the product of errors that are learned in cycle benchmarking to determine other measurement errors, such as state errors of the qubit.

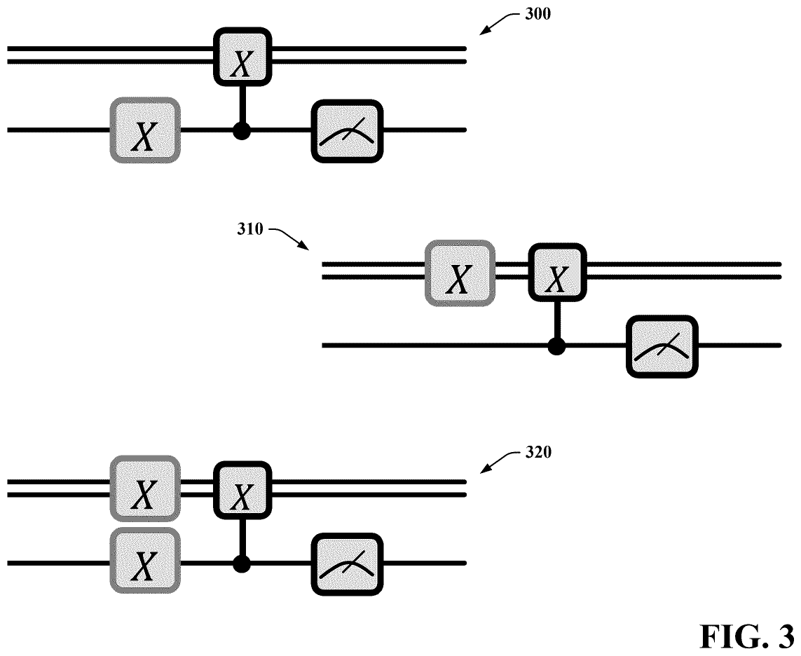

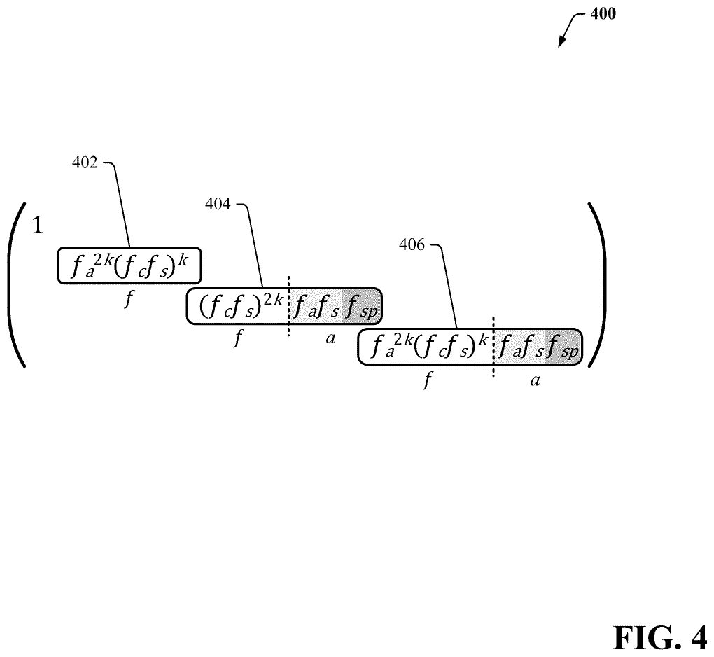

FIGS. 3 and 4 are intended to provide further description of noise models learned from cycle benchmarking. Repetitive description of like elements and/or processes employed in respective embodiments is omitted for sake of brevity.

FIG. 3 illustrates diagrams of example, non-limiting quantum circuits 300, 310, and 320 associated with measurement errors in accordance with one or more embodiments described herein.

In non-limiting quantum circuits 300, 310, and 320 involve a qubit and a classical bit. Further, as shown, non-limiting quantum circuits 300, 310, and 320 comprise Pauli-X gates, CNOT gates, and measurements on the qubit or classical bit. Note that, from herein, the notation f_{*}:=1−2p_{*} is used, where * denotes corresponding variables that represent errors (e.g., fₛ:=1−2pₛ).

A state error involves a bit-flip only on the qubit with probability pₛ, and can be represented by the following matrix.

$${Γ}_{s} = ( \begin{matrix}1 & 0 \\ 0 & {f}_{s}\end{matrix} ) ⊗ I ,$$

where I denotes the identity matrix.

Non-limiting quantum circuit 300 can be associated with a noisy measurement resulting from a state error, where [symbol] =(1−pₛ)ρ+pₛXIρXI describes the probabilistic nature of the state error. As such, [symbol] denotes the resulting density matrix after considering the state error, ρ denotes the initial quantum state (density matrix), and X denotes the Pauli-X gate.

An assignment error involves a bit-flip only on the classical bit with probability pₐ, and can be represented by the following matrix.

$${Γ}_{a} = I ⊗ ( \begin{matrix}1 & 0 \\ 0 & {f}_{a}\end{matrix} )$$

Non-limiting quantum circuit 310 can be associated with a noisy measurement resulting from an assignment error, where [symbol] =(1−pₐ)ρ+pₐIXρIX describes the probabilistic nature of the assignment error. As such, [symbol] denotes the resulting density matrix after considering the assignment error.

A correlated error involves a bit-flip on the qubit and on the classical bit with probability p_{c}, and can be represented by the following matrix.

$${Γ}_{c} = ( \begin{matrix}1 & & & \\ & {f}_{c} & & \\ & & {f}_{c} & \\ & & & 1\end{matrix} )$$

Non-limiting quantum circuit 320 can be associated with a noisy measurement resulting from an assignment error, where [symbol] =(1−p_{c})ρ+p_{c}XXρXX describes the probabilistic nature of the correlated error. As such, [symbol] denotes the resulting density matrix after considering the correlated error.

An overall mid-circuit measurement error matrix from non-limiting quantum circuits 300, 310, and 320 can be defined by [symbol] =Γ_{cnot}Γ_{Λ}, where Γ_{cnot} denotes an error matrix specific to the CNOT gate, and Γ_{Λ} denotes an error matrix that accounts for the noise in the quantum system (e.g., state errors, assignment errors, correlated errors). For a single repetition, the overall mid-circuit measurement error matrix can be defined by the following.

$$= ( \begin{matrix}1 & & & \\ & & & {f}_{a} {f}_{s} \\ & & {f}_{c} {f}_{s} & \\ & {f}_{c} {f}_{a} & & \end{matrix} )$$

For 2k repetitions where k is any positive integer, the overall mid-circuit measurement error matrix can be defined by the following.

$$= ( \begin{matrix}1 & & & \\ & {{f}_{a}^{2 k} ( {f}_{c} {f}_{s} )}^{k} & & \\ & & {( {f}_{c} {f}_{s} )}^{2 k} & \\ & & & {{f}_{a}^{2 k} ( {f}_{c} {f}_{s} )}^{k}\end{matrix} )$$

Now turning to FIG. 4, FIG. 4 illustrates a diagram of an example, non-limiting Pauli transfer matrix 400 associated with a noise model from cycle benchmarking in accordance with one or more embodiments described herein.

In addition to mid-circuit measurement errors, it can be desirable to learn state preparation and measurement (SPAM) errors, such as state preparation errors and final measurement errors.

For a state preparation error, the qubit starts in the state |1 [symbol] with a probability pₛₚ, and can be represented by the following matrix.

$${Γ}_{sp} = ( \begin{matrix}1 & 0 \\ 0 & {f}_{sp}\end{matrix} ) ⊗ I$$

Further, the final measurement error can be represented by the following matrix.

$${Γ}_{fm} = ( \begin{matrix}1 & 0 \\ 0 & {f}_{a} {f}_{s}\end{matrix} ) ⊗ I$$

For the errors described above, the resulting Pauli Transfer Matrix (PTM) that results from the full noise model learned in cycle benchmarking can be represented by non-limiting PTM 400. Non-limiting PTM 400 can be a 4ⁿ×4ⁿ matrix that represents an n-qubit quantum channel, where entries in non-limiting PTM 400 are given by

$${R}_{i , j} = \frac{1}{{2}^{n}} Tr [ {P}_{i} ε ( {P}_{j} ) ] .$$

As stated elsewhere herein, non-limiting PTM 400 can comprise the product of errors that are learned from cycle benchmarking. More specifically, the learnable terms in non-limiting PTM 400 comprise term 402

$$( e . g . , {{f}_{a}^{2 k} ( {f}_{c} {f}_{s} )}^{k} ) ,$$

term 404

$$( e . g . , {( {f}_{c} {f}_{s} )}^{2 k} {f}_{a} {f}_{s} {f}_{sp} ) ,$$

and term 406

$$( e . g . , {{f}_{a}^{2 k} ( {f}_{c} {f}_{s} )}^{k} {f}_{a} {f}_{s} {f}_{sp} ) .$$

In various aspects, k can denote the number of repetitions of performing the quantum operations in quantum circuit 120 during cycle benchmarking.

In various embodiments, the mid-circuit measurement errors can be fitted to af^{k} to model how errors accumulate over repeated cycles of quantum operations, specifically by focusing on the exponential decay of a signal over time. The term af^{k} represents a fitting function where a is an amplitude factor, which accounts for the initial signal strength or the starting point of the measurement signal, and f is a decay factor (or fidelity parameter), which represents the rate at which the signal decays due to errors in the repeated quantum operations. As shown, the product of errors in the learnable terms can be fitted to the amplitude factor.

However, error mitigation requires knowledge of the individual errors. Thus, it can be desirable to split the products fₛf_{c} and fₛfₛₚ. Therefore, by learning only one of fₛ, fₛₚ or f_{c}, the other errors can be learned as well. As stated elsewhere herein, various embodiments described herein can provide a method to determine the state preparation errors fₛₚ by initializing the qubit with a known state. Accordingly, by learning the state preparation errors fₛₚ, the state errors fₛ, the correlated errors f_{c}, and the assignment errors fa can also be determined. This can enable a more accurate, adaptable, and predictive noise model for effective error mitigation when fitting the noise model from the cycle benchmarking.

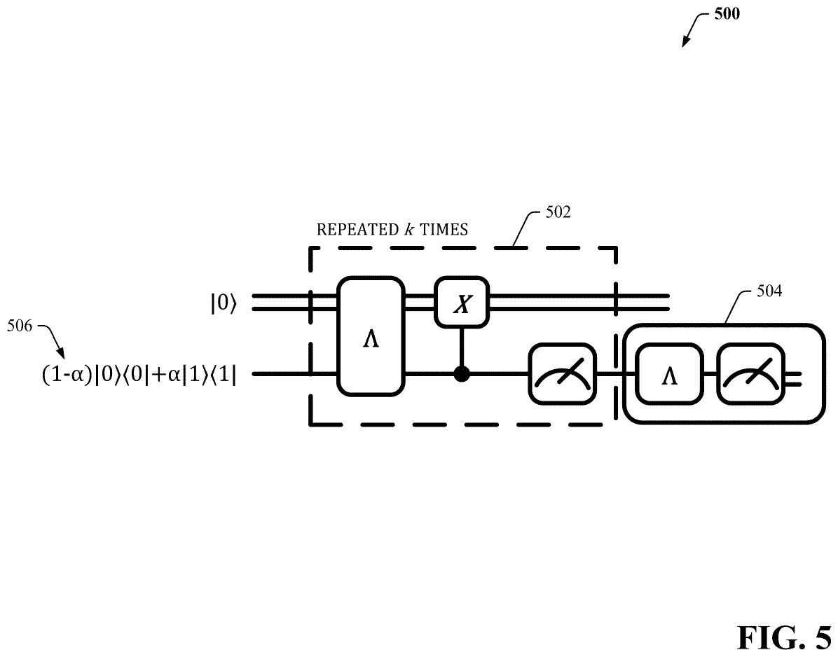

FIG. 5 illustrates a diagram of an example, non-limiting quantum circuit 500 for cycle benchmarking with an initialized known state of a qubit in accordance with one or more embodiments described herein. Repetitive description of like elements and/or processes employed in respective embodiments is omitted for sake of brevity.

In various instances, non-limiting quantum circuit 500 can be an example implementation of quantum circuit 120. As discussed with reference to FIGS. 1 and 2, initialization component 202 can initialize the qubit with a known state. For example, the known state can be a thermal state 506 defined by (1−α)|0 [symbol] 0|+α|1 [symbol] 1|. As shown, non-limiting quantum circuit 500 can comprise or consist of a noise learning circuit 502. In various aspects, the noise learning circuit 502 can be the quantum operations that are repeatedly executed during cycle benchmarking to learn noise of the measurements in non-limiting quantum circuit 500. In various embodiments, execution component 206 can perform cycle benchmarking on the mid-circuit measurements by repeating execution of noise learning circuit 502 k times. For each execution, execution component 206 can use a passive qubit reset, similarly to when the known state is initialized with a passive qubit reset. In various embodiments, execution component 206 can apply the passive qubit reset until the qubit reaches the known state.

Furthermore, in various embodiments, execution component 206 can insert a delay for each repetition of execution. For example, execution component 206 can perform the cycle benchmarking with a repetition delay, where the repetition delay can be similar to the delay inserted into the beginning of quantum circuit 120 to measure the thermal population of the qubit. In addition, in various embodiments, a final measurement 504 is included in the cycle benchmarking noise learning to measure the final state of the qubit after the last mid-circuit measurement. This enables a complete characterization of the noise model.

In various embodiments, execution component 206 can first perform cycle benchmarking with the passive qubit reset to more accurately characterize noise. For example, learning noise with a passive qubit reset is often more accurate than learning noise with an active qubit reset because passive qubit reset allows the qubit to return to its thermal equilibrium state naturally, minimizing additional sources of error introduced by the reset process itself. Thereafter, execution component 206 can separate the state preparation errors learned by initializing the qubit with the known state from the state errors. After accurately characterizing the noise using the passive qubit reset, execution component 206 can perform cycle benchmarking with an active qubit reset to improve efficiency of error mitigation using the characterized noise. That is, it can be more desirable to implement active qubit resets as opposed to passive qubit resets due to reduced downtime and improved circuit efficiency that results from active qubit resets. Therefore, to enable effective error mitigation when using active qubit resets, execution component 206 can perform cycle benchmarking with the active qubit reset, where execution component can leverage the noise learned from the passive qubit reset to characterize the noise during an active qubit reset. Then, execution component 206 can separate the state preparation errors from the state errors. For example, execution component 206 can learn the state error fₛ of the qubit that occurs in each repetition of execution from cycle benchmarking with the passive qubit reset. Accordingly, execution component 206 can use such state errors to more accurately characterize the noise for cycle benchmarking with the active qubit reset.

In various embodiments, alternatively to measuring after each layer in the noise learning circuit 502 to learn the noise model, execution component 206 can learn the noise model using a single circuit that comprises twirled measurements. Similarly, the single circuit with the twirled measurements can be performed with the passive qubit reset.

FIG. 6 illustrates a diagram of an example, non-limiting Rabi experiment 600 for measuring thermal population of a qubit in accordance with one or more embodiments described herein. Repetitive description of like elements and/or processes employed in respective embodiments is omitted for sake of brevity.

As discussed with reference to FIGS. 1 and 2, measurement component 204 can measure the thermal population of a qubit, which can enable determination of state errors from the product or errors that are learned in cycle benchmarking.

For example, measurement component 204 can perform non-limiting Rabi experiments 600 to measure the thermal population a of the excited state of the qubit in a thermal state (labeled pₛₚ before). Though, in various aspects, any suitable method can be implemented to measure the thermal population of the qubit. As state elsewhere herein, execution component can insert a delay into quantum circuit 120 to measure the thermal population.

In various embodiments, non-limiting Rabi experiments 600 can involve two Rabi experiments between a first excited state 604 and a second excited state 602 of the qubit. Each Rabi experiment can follow different initializations (π and no-π). That is, one of the Rabi experiments can initialize the qubit using a π-pulse initialization and can initialize the qubit without the π-pulse initialization in the other Rabi experiment. A π-pulse refers to an electromagnetic pulse with an adequate amplitude and duration to rotate a qubit's state by x radians, or 180 degrees, on the Bloch sphere. The π-pulse drives the qubit from one state to another, such as from the ground state |0 [symbol] to the first excited state |1 [symbol] . More specifically, the x-pulse can be applied to “flip” the thermal population from (1−α)|0 [symbol] 0|+α|1 [symbol] 1| to (1−α)|1 [symbol] 1|+α|0 [symbol] 0|. Without the π-pulse initialization, no pulse is applied, so the qubit remains in the thermal state.

In various embodiments, measurement component 204 can drive oscillations 606 (e.g., apply an external electromagnetic field at a resonant frequency that matches the energy difference between the first excited state 604 and the second excited state 602) between the first excited state 604 and the second excited state 602. The frequency of oscillations between the states (Rabi frequency) depends on the amplitude of the applied driving field. The resulting signal from the |1 [symbol] ↔|2 [symbol] drive amplitude from no π-pulse initialization is depicted by graph 608. The amplitude of oscillations 606 without π-pulse initialization is then proportional to the thermal population a. The resulting signal from the |1 [symbol] ↔|2 [symbol] drive amplitude from no π-pulse initialization is depicted by graph 610. The amplitude of oscillations 606 with π-pulse initialization is then proportional to the complement of the thermal population (1−a). In various embodiments, measurement component 204 can determine the thermal population a by taking a ratio of the signal without π-pulse initialization and the signal with π-pulse initialization. This way, measurement component 204 can extract the thermal population from the ratio.

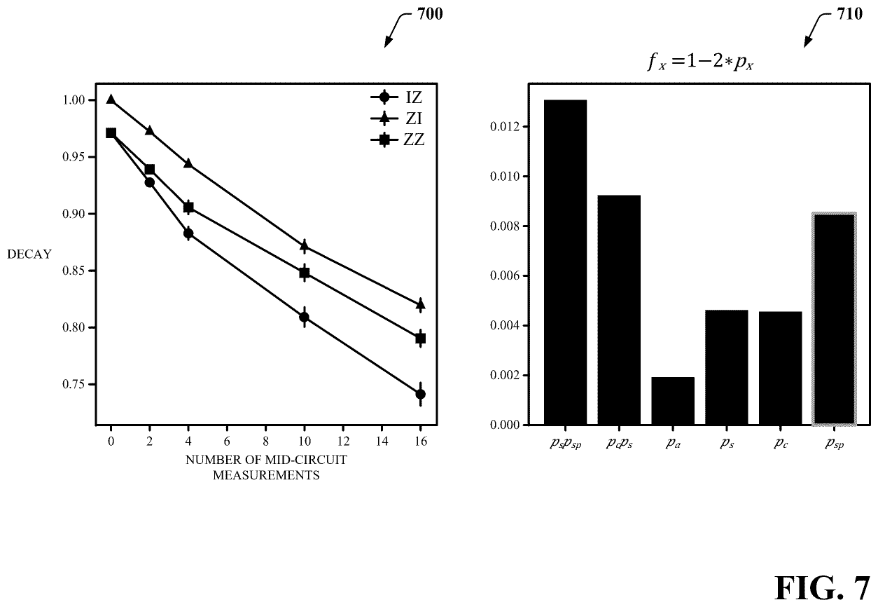

FIG. 7 illustrates diagrams of example, non-limiting graphs 700 and 710 of an example implementation in accordance with one or more embodiments described herein. Repetitive description of like elements and/or processes employed in respective embodiments is omitted for sake of brevity.

Non-limiting graphs 700 and 710 depict data from an exemplary implementation of the proposed method. In other words, non-limiting graphs 700 and 710 depict the results of noise learning of mid-circuit measurements with thermal states created through a passive qubit reset. Before measuring the thermal state population and in between circuit executions of cycle benchmarking, there is a 10 ms delay, which is more than 10 times the T₁ time. Non-limiting graph 700 depicts the decay of the qubit's state over increasing measurement cycles. As shown, as the number of mid-circuit measurements increases, the decay decreases, indicating longer coherence times. Non-limiting graph 700 depicts the errors learned in cycle benchmarking. As shown, by the various embodiments of the present disclosure provide a method to distinguish each error from the product of errors learned in cycle benchmarking. This is achieved by first learning the state preparation errors pₛₚ, which then allows separation of the state errors pₛ from learned product pₛpₛₚ. After obtaining state errors pₛ, the correlated errors p_{c} can be separated from learned product p_{c}pₛ.

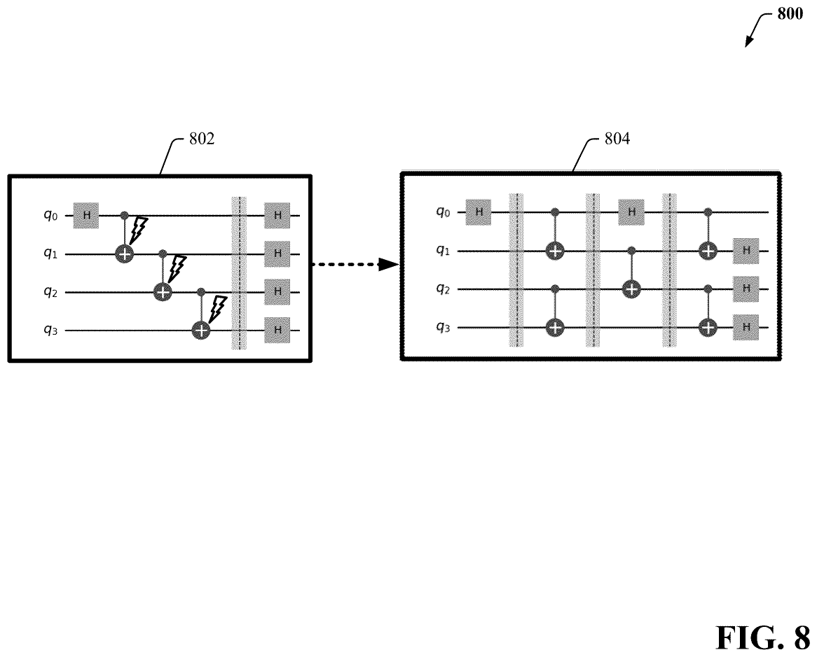

FIG. 8 illustrates a diagram of an example, non-limiting quantum circuit implementation 800 in accordance with one or more embodiments described herein. Repetitive description of like elements and/or processes employed in respective embodiments is omitted for sake of brevity.

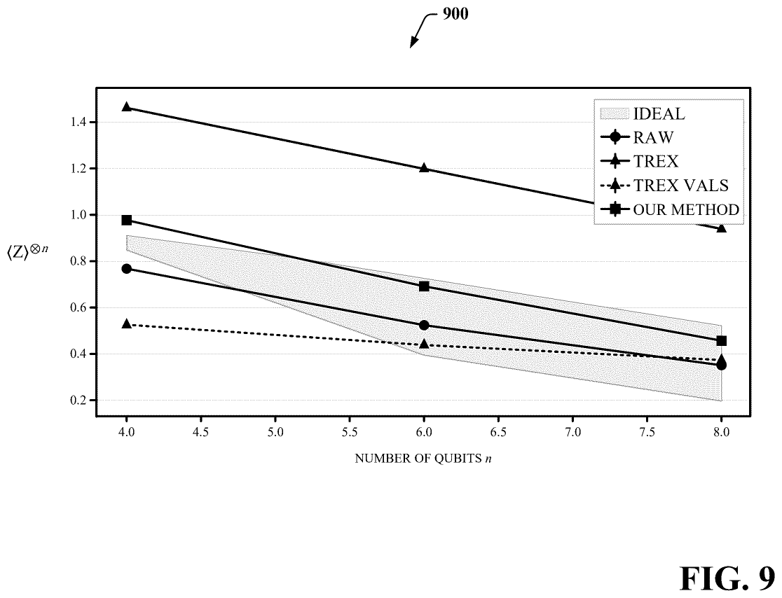

Non-limiting quantum circuit implementation 800 depicts example quantum circuits that are very susceptible to state preparation errors when measuring the all-Z observable. Circuit 802 depicts a quantum circuit that is sensitive to state preparation errors, and where the observable of interest is [symbol] . Furthermore, circuit 802 maps I . . . IZ to Z . . . Z and circuit 804 is a probabilistic error cancelation (PEC) amenable circuit. In the example implementation, n qubits are chosen and the thermal population for each qubit is obtained. Then, TREX is applied on the n qubits with passive delays (e.g., long delays), and the observable of interest is computed. Thereafter, circuit 802 is executed with long delays where circuit 804 is executed for the CNOT gates, and [symbol] Õ [symbol] is computed. Then, [symbol] Õ [symbol] is mitigated with TREX and the proposed method. TREX results in a mitigated observable of

$$\frac{〈 O 〉}{{\prod }_{i \neq 0} {f}_{i}^{sp}} ,$$

whereas the proposed method results in a mitigates observable of [symbol] O [symbol] , eliminating the dependence on the error factors fᵢ^{sp}. In other words, TREX exhibits sensitivity to state preparation errors, and can thus fail to provide effective error mitigation. Conversely, the proposed method can provide improved error mitigation. Further experiment results are discussed with respect to FIG. 9.

FIG. 9 illustrates a diagram of an example, non-limiting graph 900 of experiment results of the proposed method and existing methods in accordance with one or more embodiments described herein. Repetitive description of like elements and/or processes employed in respective embodiments is omitted for sake of brevity.

As demonstrated by non-limiting graph 900, the method proposed in the present disclosure (depicted by the line with square markers) significantly outperforms existing methods, such as TREX (depicted by the line with triangle markers). Using the example implementation from FIG. 8, TREX overshoots the ideal values (depicted by a gray shading) due to removing too much error from the raw data (depicted by the line with circle markers) while the proposed method lies within the ideal values, even as the number of qubits n increases.

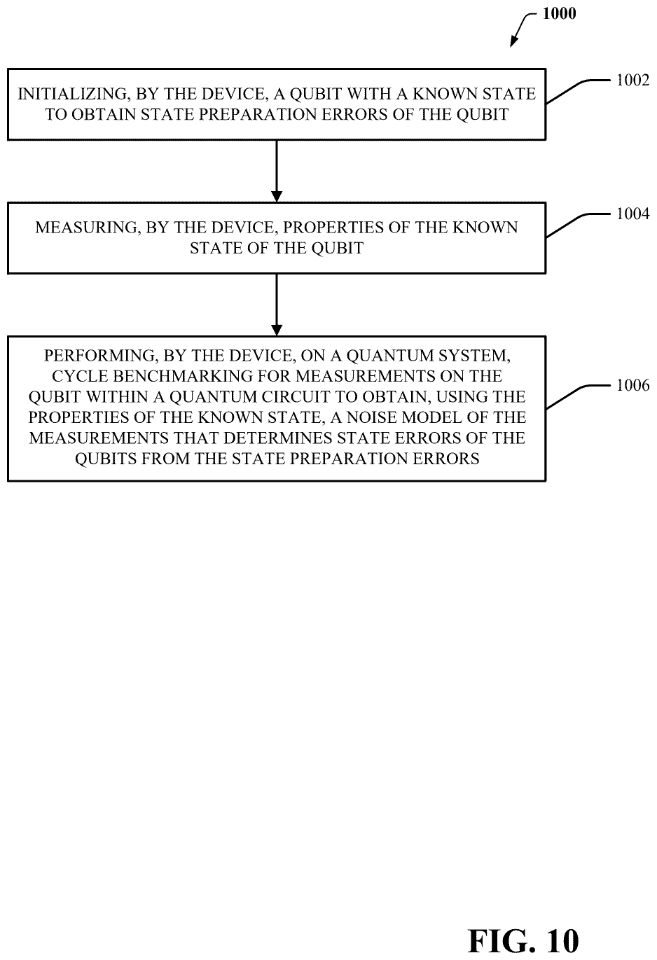

FIG. 10 illustrates an example, non-limiting logical operator gauging algorithm 1000 in accordance with one or more embodiments described herein. Repetitive description of like elements and/or processes employed in respective embodiments is omitted for sake of brevity.

At 1002, non-limiting method 1000 can comprise initializing (e.g., by initialization component 202), by the system, a qubit with a known state to obtain state preparation errors of the qubit.

At 1004, non-limiting method 1000 can comprise measuring (e.g., by measurement component 204), by the system, properties of the known state of the qubit.

At 1006, non-limiting method 1000 can comprise performing (e.g., by execution component 206), by the system, on a quantum system, cycle benchmarking for measurements on the qubit within a quantum circuit to obtain, using the properties of the known state, a noise model of the measurements that determines state errors of the qubit from the state preparation errors.

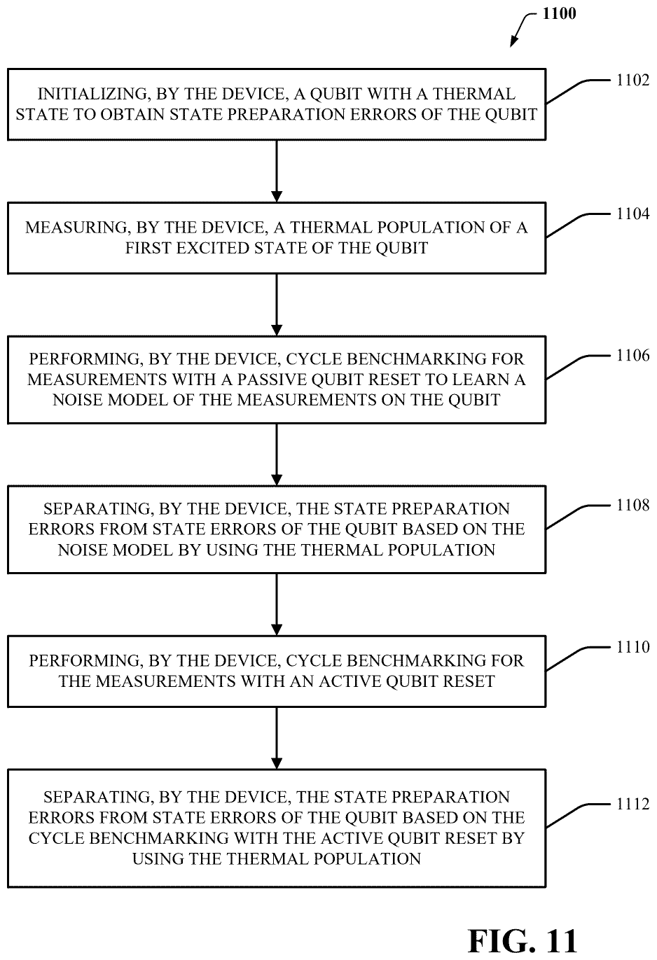

FIG. 11 illustrates an example, non-limiting logical operator gauging algorithm 1100 in accordance with one or more embodiments described herein. Repetitive description of like elements and/or processes employed in respective embodiments is omitted for sake of brevity.

At 1102, non-limiting method 1100 can comprise initializing (e.g., by initialization component 202), by the system, a qubit with a thermal state to obtain state preparation errors of the qubit.

At 1104, non-limiting method 1100 can comprise measuring (e.g., by measurement component 204), by the system, a thermal population of a first excited state of the qubit.

At 1106, non-limiting method 1100 can comprise performing (e.g., by execution component 206), by the system, cycle benchmarking for measurements with a passive qubit reset to learn a noise model of the measurements on the qubit.

At 1108, non-limiting method 1100 can comprise separating (e.g., by execution component 206), by the system, the state preparation errors from state errors of the qubit based on the noise model by using the thermal population.

At 1110, non-limiting method 1100 can comprise performing (e.g., by execution component 206), by the system, cycle benchmarking for the measurements with an active qubit reset.

At 1112, non-limiting method 1100 can comprise separating (e.g., by execution component 206), by the system, the state preparation errors from state errors of the qubit based on the cycle benchmarking with the active qubit reset by using the thermal population. In various aspects, the separating of state preparation errors from state errors can be further based on the noise model learned from the cycle benchmarking with the passive qubit reset.

In various aspects, it may not be desirable to execute a quantum application using passive qubit resets. Therefore, by learning the noise model for mid-circuit measurements using the passive qubit reset, the noise model can be leveraged when performing the cycle benchmarking with the active qubit reset to learn a noise model for active qubit resets. More specifically, the state preparation errors can then also be learned with active qubit resets. Thus, the quantum application of interest can be executed with effective read-out error mitigation. A consistent noise learning with an active qubit reset can be achieved by leveraging the noise learning at 1108 with the thermal population obtained with the passive qubit reset. The noise learning at 1108 with a passive qubit reset generates a noise model of the mid-circuit measurements that is not contaminated by state preparation errors. Therefore, the noise model of the mid-circuit measurements is leveraged to learn the state preparation error of the active qubit reset.

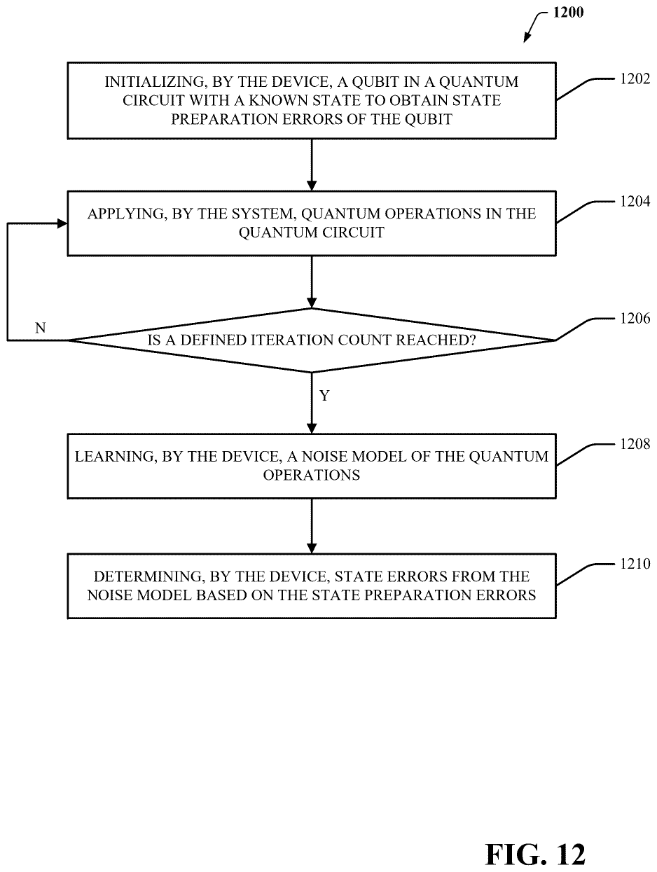

FIG. 12 illustrates an example, non-limiting logical operator gauging algorithm 1200 in accordance with one or more embodiments described herein. Repetitive description of like elements and/or processes employed in respective embodiments is omitted for sake of brevity.

At 1202, non-limiting method 1200 can comprise initializing (e.g., by initialization component 202), by the system, a qubit in a quantum circuit with a known state to obtain state preparation errors of the qubit.

At 1204, non-limiting method 1200 can comprise applying (e.g., by execution component 206), by the system, quantum operations in the quantum circuit.

At 1206, non-limiting method 1200 can comprise determining (e.g., by measurement component 204), by the system, whether a defined iteration count has been reached. If yes, then non-limiting method 1200 can proceed to 1208. If not, then non-limiting method 1200 can proceed to 1204. In various aspects, the defined iteration count can be any desired iteration parameter received as input and can be any positive integer.

At 1208, non-limiting method 1200 can comprise learning (e.g., by execution component 206), by the system, a noise model of the quantum operations.

At 1210, non-limiting method 1200 can comprise determining (e.g., by execution component 206), by the system, state errors from the noise model based on the state preparation errors.

FIG. 13 illustrates a block diagram of an example, non-limiting, operating environment 1300 in which one or more embodiments described herein can be facilitated. FIG. 13 and the following discussion are intended to provide a general description of a suitable operating environment 1300 in which one or more embodiments described herein at FIGS. 1-12 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as noise learning of measurements with known state initialization code 1328. In addition to block 1328, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1328, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer-readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1328 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1328 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer-readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

CLOUD COMPUTING SERVICES AND/OR MICROSERVICES (not separately shown in FIG. 13): private and public clouds 1306 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an initialization component that initializes a qubit with a known state to obtain state preparation errors of the qubit;
a measurement component that measures properties of the known state of the qubit; and
an execution component that performs, on a quantum system, cycle benchmarking for measurements on the qubit within a quantum circuit to obtain, by using the properties of the known state, a noise model of the measurements that determines state errors of the qubit from the state preparation errors.

2. The system of claim 1, wherein the known state is a thermal state, and wherein the properties of the known state include a thermal population of a first excited state of the qubit.

3. The system of claim 2, wherein the initialization component initializes the qubit with the thermal state using a passive qubit reset in noise learning circuits of the quantum circuit.

4. The system of claim 2, wherein the execution component further:
performs, on the quantum system, cycle benchmarking for the measurements with a passive qubit reset to learn the noise model of the measurements of the qubit; and
separates, based on the noise model, the state preparation errors from the state errors using the thermal population of the qubit.

5. The system of claim 4, wherein the execution component learns the noise model by executing a single circuit with twirled measurements and the passive qubit reset.

6. The system of claim 4, wherein the execution component further:
performs, on the quantum system, cycle benchmarking for the measurements with an active qubit reset in response to learning the noise model using the passive qubit reset; and
separates, based on the noise model or the cycle benchmarking for the measurements with the active qubit reset, the state preparation errors from the state errors using the thermal population of the qubit.

7. The system of claim 2, wherein the initialization component inserts a delay in the quantum circuit to initialize the qubit with the thermal state.

8. The system of claim 4, wherein the initialization component performs the cycle benchmarking for the measurements with the passive qubit reset with a delay.

9. The system of claim 2, wherein measuring the thermal population of the qubit comprises:
driving oscillations between the first excited state and a second excited state of the qubit.

10. The system of claim 9, wherein the initialization component extracts the thermal population of the qubit from a ratio of the oscillations with a n-pulse initialization to the oscillations without the It-pulse initialization.

11. The system of claim 10, wherein the oscillations without the T-pulse initialization have an amplitude proportional to the thermal population of the qubit, and wherein the oscillations with the T-pulse initialization have an amplitude proportional to one minus the thermal population of the qubit.

12. A computer-implemented method, comprising:
initializing, by a system operatively coupled to a processor, a qubit with a known state to obtain state preparation errors of the qubit;
measuring, by the system, properties of the known state of the qubit; and
performing, by the system, on a quantum system, cycle benchmarking for measurements on the qubit within a quantum circuit to obtain, by using the properties of the known state, a noise model of the measurements that determines state errors of the qubit from the state preparation errors.

13. The computer-implemented method of claim 12, wherein the known state is a thermal state, and wherein the properties of the known state include a thermal population of a first excited state of the qubit.

14. The computer-implemented method of claim 13, further comprising:
initializing, by the system, the qubit with the thermal state using a passive qubit reset in noise learning circuits of the quantum circuit.

15. The computer-implemented method of claim 13, further comprising: further comprises:
performing, by the system, on the quantum system, cycle benchmarking for the measurements with a passive qubit reset to learn the noise model of the measurements of the qubit; and
separating, by the system, based on the noise model, the state preparation errors from the state errors using the thermal population of the qubit.

16. The computer-implemented method of claim 15, further comprising:
performing, by the system, on the quantum system, cycle benchmarking for the measurements with an active qubit reset in response to learning the noise model using the passive qubit reset; and
separating, by the system, based on the noise model or the cycle benchmarking for the measurements with the active qubit reset, the state preparation errors from the state errors using the thermal population of the qubit.

17. The computer-implemented method of claim 13, further comprising:
inserting, by the system, a delay in the quantum circuit to initialize the qubit with the thermal state.

18. The computer-implemented method of claim 13, wherein measuring the thermal population of the qubit comprises:
driving oscillations between the first excited state and a second excited state of the qubit.

19. A computer program product for noise learning of measurements in a quantum circuit, the computer program product comprising a computer readable storage medium having program instructions embodied therewith, the program instructions executable by a processor to cause the processor to:
initialize, by the processor, a qubit with a known state to obtain state preparation errors of the qubit;
measure, by the processor, properties of the known state of the qubit; and
perform, by the processor, on a quantum system, cycle benchmarking for measurements on the qubit within a quantum circuit to obtain, by using the properties of the known state, a noise model of the measurements that determines state errors of the qubit from the state preparation errors.

20. The computer program product of claim 19, wherein the known state is a thermal state, and wherein the properties of the known state include a thermal population of a first excited state of the qubit.
